(19) United States
(12) Patent Application Publication
(10) Pub. No.: US 2008/0315675 A1
(43) Pub. Date: Dec. 25, 2008

(54) WHEEL WITH DETACHABLE SPOKE MADE OF COMPOSITE MATERIAL

(75) Inventors: Karim Taieb, Rumilly (FR); Benoit Saillet, Albens (FR); Philippe Renard, Aix Les Bains (FR)

Correspondence Address: GREENBLUM & BERNSTEIN, P.L.C., 1950 ROLAND CLARKE PLACE, RESTON, VA, 20191, US

(73) Assignee: SALOMON S.A., Metz-Tessy (FR)

(21) Appl. No.: 12/144,950

(22) Filed: Jun. 24, 2008

(30) Foreign Application Priority Data
Jun. 25, 2007 (FR) 07.04547

(51) Int. Cl. B60B 1/04; B60B 1/00

(52) U.S. Cl. 301/56; 301/104

(57) ABSTRACT

The invention relates to a wheel including a rim, a hub, at least one spoke connecting the rim to the hub, the spoke being made of composite material. Each spoke of the wheel includes a device enabling a reversible connection with the hub of the wheel, the connection device being at least partially incorporated within the spoke by co-molding therewith.

### CROSS-REFERENCE TO RELATED APPLICATION

This application claims priority under 35 U.S.C. §119 of French Patent Application No. 07 04547, filed on Jun. 25, 2007, the disclosure of which is hereby incorporated by reference thereto in its entirety.

### BACKGROUND OF THE INVENTION

1. Field of the Invention

The invention relates to wheels having spokes made of composite material.

2. Description of Background and Other Information

Spokes made of composite material have the advantage of being lighter and stronger than the more conventional spokes made of metal.

Conversely, spokes made of composite material have the drawback of a more complicated attachment to the hub and to the rim, due to the types of composite materials that are used. Indeed, with regard to a spoke made of composite material in the form of carbon fibers embedded in a resinous matrix, such a fibrous spoke does not lend itself to the simple threading and deformation operations that are applicable to a metal spoke for making its ends capable of being attached to the hub and the rim.

A known solution for attaching a spoke made of composite material to the rim involves molding the spoke and the rim together. The drawback of this method for assembling the spoke and the rim becomes apparent when the spoke breaks due, for example, to fatigue. In this case, the wheel cannot be repaired because the spoke is irreversibly attached to the rim during molding. The entire wheel must be replaced, which is quite expensive.

The document FR 2 707 559 A1 describes a spoke made of metal or of composite material, which is removably connected to the hub via its inner end. The connection is done by means of a threaded end piece that includes two parallel walls defining a cap forming a central housing in which the corresponding end of the spoke is engaged and soldered, glued or welded, in order to affix the end piece to the spoke.

The use of such an end piece for the connection enables the spoke to be removable from the hub. Conversely, this solution is not satisfactory insofar as the attachment zone between the end piece and the remainder of the spoke constitutes a weakening zone. Indeed, during use, the spoke is biased in traction, which tends to separate the end piece from the remainder of the spoke. The glue that fixes the end piece to the remainder of the spoke must be of very good quality to prevent the spoke from breaking, which is not always the case.

### SUMMARY OF THE INVENTION

The invention provides a spoke made of composite material, with a device that enables a reversible connection between the composite spoke and the wheel (rim, hub) of the type known from the aforementioned document FR 2 707 559 A1.

In addition, the invention improves the connection, in particular with respect to the already known connection devices.

Further, the invention provides a spoke that can be manufactured more easily than the spoke known from the document FR 2 707 559 A1. Indeed, the solution according to this document, using an end piece, adds an additional step to the manufacture of the spoke, namely the step of gluing the end piece to the remainder of the spoke.

More generally, the invention provides a spoke made of composite material, which can be more easily replaced within the wheel, if broken during use.

Still further, the invention provides for the manufacture of a wheel that can be adjusted and repaired by means of spokes made of composite material.

In these regards, a wheel according to the invention includes at least one spoke made of composite material, with the spoke including a connection device that enables a reversible connection with the wheel, and with the connection device being at least partially incorporated in the spoke by co-molding or overmolding.

Reversible connection means that the spoke can be attached to the wheel (rim, hub) while being easily removable or detachable, if necessary. It may be necessary if the spoke breaks and must be replaced.

According to one embodiment, the spoke is a double spoke, i.e., a spoke extending substantially across the entire diameter of an associated wheel. Thus, the spoke according to the invention is adapted to be attached by its two ends to a wheel rim, whereas its central portion is adapted to be attached to the hub. The reversible connection device can therefore be arranged in the area of the central portion of the spoke.

The fact that the connection device is at least partially incorporated in the spoke by co-molding makes the connection between these two elements stronger and more reliable. Indeed, the connection device is more or less surrounded or framed by the composite material, which maximizes the attachment surface between the device and the material.

The device is integrated into the spoke when the latter is being molded. The composite material and the connection device, which is at least partially set therein, are positioned together in a mold in order to be shaped and to be subject to a rise in temperature. After moldings the connection device is properly glued, at least partially, inside the spoke.

In one embodiment, the connection device is inserted and maintained between two longitudinal outer surfaces of the spoke. Thus, the connection device can be covered by the spoke, either from the top or from the bottom, or from both sides. The covering is preferably partial, but could be complete.

According to one embodiment, the connection device is a plate inserted between composite layers of the spoke.

Advantageously, the spoke has two superimposed composite layers on one surface of the plate. This reduces the risk of delamination of the two layers when the spoke is being mounted, and therefore reduces the risk of breaking, especially when the spoke flexes. Furthermore, the covering, necessary for assembling the spoke, is thus carried out (symmetrically) in the central zone of the spoke; this does not induce any unbalance with respect to the wheel.

Furthermore, the plate can include a longitudinal groove for housing at least one composite layer of the spoke. Advantageously, the surface of the composite layer(s) arranged in the groove is flush with the outer surface of the plate.

With a grooved plate, the two superimposed composite layers can be housed in a first, deeper groove of the plate defining a housing that is adapted to the composite layers, a third composite layer being capable of being housed in a second, shallower groove.

Advantageously, the composite layers that are in the vicinity of the plate can be surrounded by a tightening strap to prevent them from delaminating.

In one embodiment, the spoke has a transition zone between the plate and the composite layers in the form of melted material.

Furthermore, the plate can be planar, i.e., parallelepiped, or can include two portions, one being inclined by a certain angle with respect to the other, so as to form a sort of herringbone.

A decorative layer can be added to the plate, thereby covering its entire surface. This layer can have a color matching the hub.

Advantageously, the plate has an elliptical shape and includes a slug for connecting with the hub.

In another embodiment, the connection device can be a shouldered pin, instead of a plate. In a detail according to an embodiment of the invention, the pin is capable of being housed in a hole of a flange of the hub.

The connection device can also be a threaded tube.

In addition, in the case of a connection device in the form of plate with a slug, a pin or a threaded tube, this device, in a particular embodiment, is incorporated in the spoke such that the fibers of the composite material entwine or surround it, i.e., the fibers are not interrupted by the device, but are only deviated.

Moreover, the connection device can have a roughened surface, obtained by blasting according to a particular embodiment, to improve the grip, i.e., adhesion, between the device and the spoke.

The invention also relates to a wheel including at least one spoke according to any of the preceding embodiments.

### BRIEF DESCRIPTION OF DRAWINGS

Other characteristics and advantages of the invention will be better understood from the description that follows, with reference to the annexed drawings showing, by way of non-limiting embodiments, how the invention can be made, and in which;

FIG. 1 is a general view of a wheel example according to the invention;

FIG. 2 is an enlarged detailed view of the wheel according to FIG. 1, showing an example of a first alternative embodiment of the device according to the invention which enables a reversible connection between the spokes and the hub of the wheel, in the case of a herringbone plate;

FIGS. 2a and 2b show different examples of the plate of FIG. 2;

FIGS. 3a and 3b show the angles of inclination of the spokes of the wheel according to FIG. 1;

FIGS. 4a, 4b, and 4c show other examples of the first alternative embodiment of the connection device according to the invention;

FIGS. 5a, 5b, 5c show additional examples of the first alternative embodiment of the connection device according to the invention;

FIG. 6 shows another embodiment of the device of FIGS. 4a, 4b, and 4c;

FIGS. 7a, 7b, and 7c show a second alternative embodiment of the connection device according to the invention;

FIGS. 8a, 8b, and 8c show a third alternative embodiment of the connection device according to the invention;

FIGS. 9a to 9d show a fourth alternative embodiment of the connection device according to the invention;

FIG. 10 shows an example of an embodiment of a spoke according to the invention, made as a double spoke;

FIG. 11 is a view of a spoke according to the invention, made as a single spoke;

FIGS. 12, 13, and 14 show other embodiments of the connection devices adapted more particularly to anchoring the spoke in the area of the rim;

FIG. 15 is a plan view with a partial cross-section in the area of the lower bridge of a wheel incorporating a spoke according to FIG. 11; and

FIG. 16 is a cross-sectional view along the line XVI-XVI of FIG. 15.

### DETAILED DESCRIPTION OF THE INVENTION

In the description that follows, the material used for the spokes is to be made of carbon fibers embedded in a polymer resin matrix. Nevertheless, this is not limiting, and the spokes can be made from any other composite material.

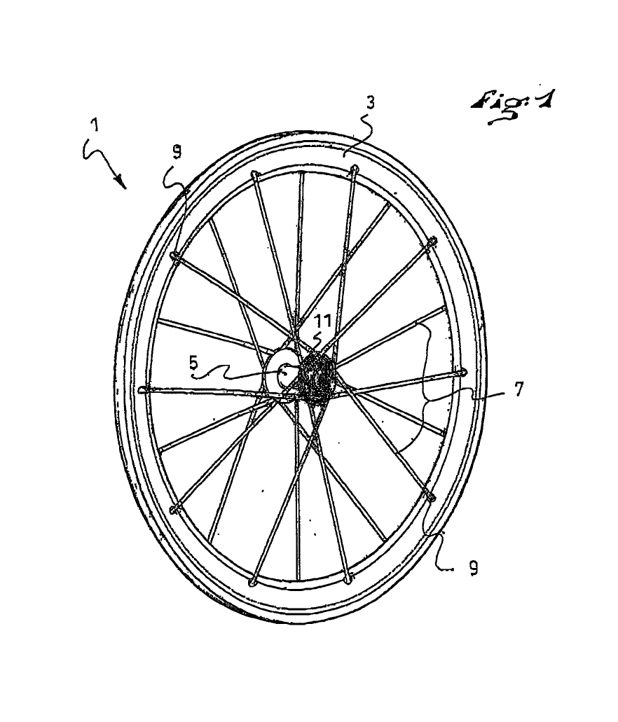

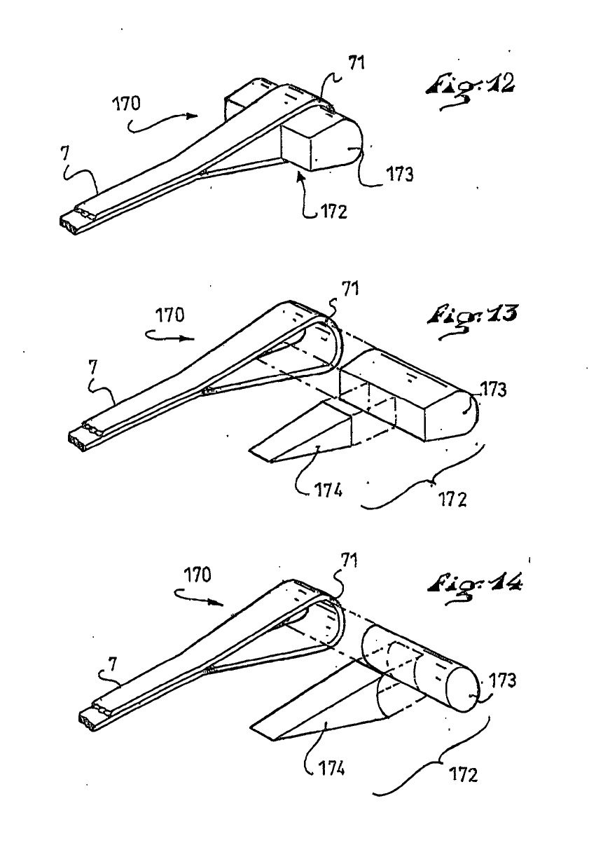

FIG. 1 provides a general view of a spoke wheel 1 according to the invention. The wheel 1 includes a rim 3, a hub 5, and spokes 7 connecting the rim to the hub. In the example shown, the spokes 7 are double spokes, i.e., they extend substantially across the entire diameter of the wheel, each of their ends 9 being connected to the rim 3, their central portion 11 being connected to the hub 5. These can also be single spokes, as described below in connection with FIGS. 11 and 15.

The spokes 7 are removably fastened in the area of the rim 3; this is described more particularly in connection with FIGS. 10 and 11.

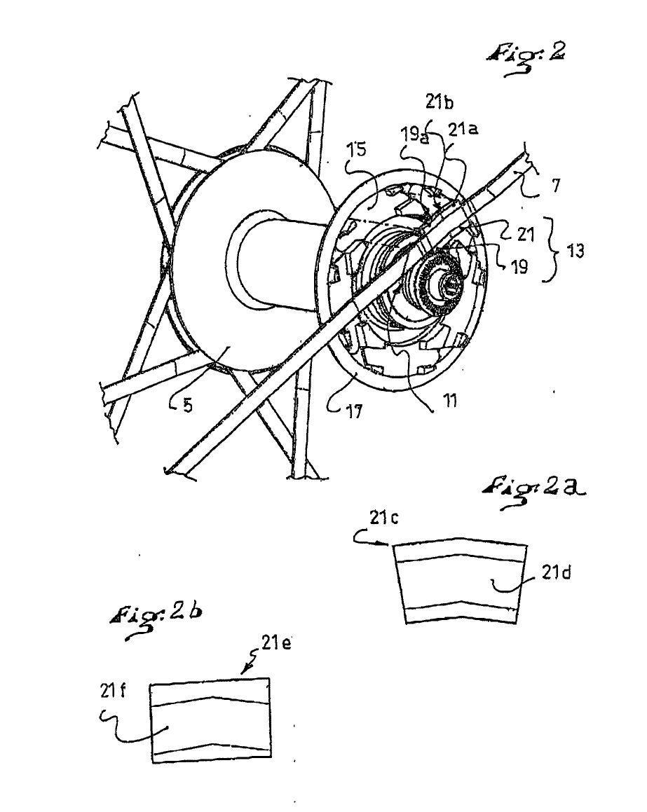

The structural arrangement for fastening the spokes 7 to the hub 5 will be next described. FIG. 2 is a detailed view of the central portion 11 of one of the double spokes 7. FIG. 2 clearly shows a first alternative removable fastening between the hub 5 and the spoke 7, namely a plate 13 integrated into the central portion 11 of the spoke 7, which is housed in one of several housings 15 whose shape is complementary to that of the plate, substantially rectangular in this case, and which are arranged in the flange 17 of the hub 5, the housings forming abutments that prevent the removal of the plate, particularly when the spokes are tensioned.

The plate 13 is substantially rectangular or parallelepiped and has two substantially square portions 19 and 21, the upper surfaces 19a, 21a of which are inclined with respect to one another by forming a sort of herringbone, whereas the lower surface 21b is common and planar. The two portions 19, 21 can be constituted by a single herringbone-shaped element 21c having a herringbone-shaped groove 21d (see FIG. 2a) or a rectangular element 21e having such a herringbone-shaped groove 21f (see FIG. 2b). The spokes 7 are embedded in the grooves 21d, 21f.

FIGS. 3a and 3b show the two angles of inclination α and β of the spokes 7. The spokes 7 are molded along these two angles, α corresponding to the “dish angle” with respect to the plane of the wheel, and β corresponding to the angle of traction,

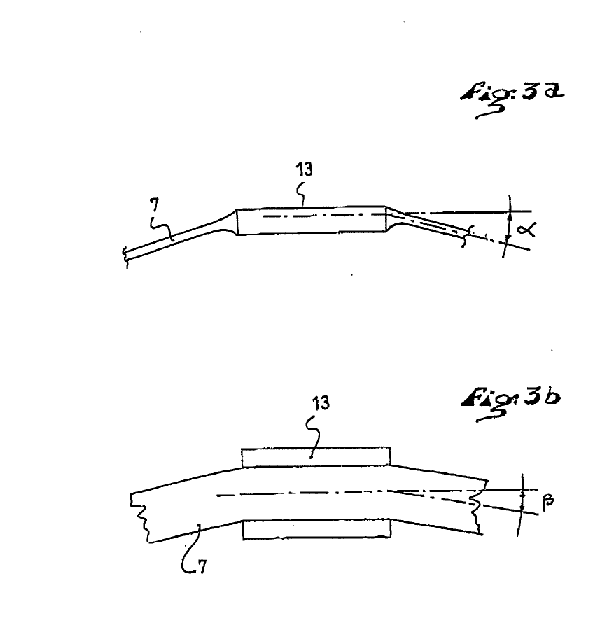

FIGS. 4a to 4c show a plate 13 in detail according to another embodiment. In fact, this plate 13 slightly differs from the plate shown in FIG. 2, in that it is a flat plate having no inclination between its two portions. The plate 13 is made such that it has large surfaces for gluing to the spoke 7.

FIG. 4a is a longitudinal cross-sectional view of the central portion 11 of the spoke 7, in the area of the plate. The spoke 7 is constituted of three layers of composite material 23, 25, and 27. The layer 23 envelops the plate 13 from the underside, from one end to the other end of the spoke 7, whereas the layers 25 and 27 extend from one end of the spoke 7, pass above the plate 13 and stop each at one of the two ends of the plate 13. Thus, the layer 25 and 27 are superimposed in the area of the upper surface of the plate 13.

With reference to FIG. 4a, the plate 13 is inserted and maintained between two longitudinal outer surfaces 33, 35 of the spoke 7.

FIG. 4b is a transverse cross-sectional view of the central portion 11 of the spoke 7, along the line IVb-IVb of FIG. 4a. FIG. 4b clearly shows that the two superimposed layers 25 and 27 are housed in a first longitudinal and open groove 29 arranged on one surface of the plate 13. The layer 23 is located in a second longitudinal and open groove 31 arranged in the lower surface of the plate. The grooves are made such that the outermost surface of the layers is flush with that of the plate. Therefore, the groove 31 is shallower than the groove 29. The two layers 25 and 27 are superimposed on the upper surface 37 of the plate 13. The plate 13 could also be said to have two longitudinal grooves 29, 31 having a rectangular cross section for housing the composite layers.

FIG. 4c illustrates the possibility of adding a decorative layer 41 above the plate 13. The color of this decorative layer 41 is the same as that of the flange 17, for example, in order to obtain a pleasant aesthetic effect. The layer can be provided to be sufficiently thick to recover forces resulting from the gluing and to increase the strength of the latter.

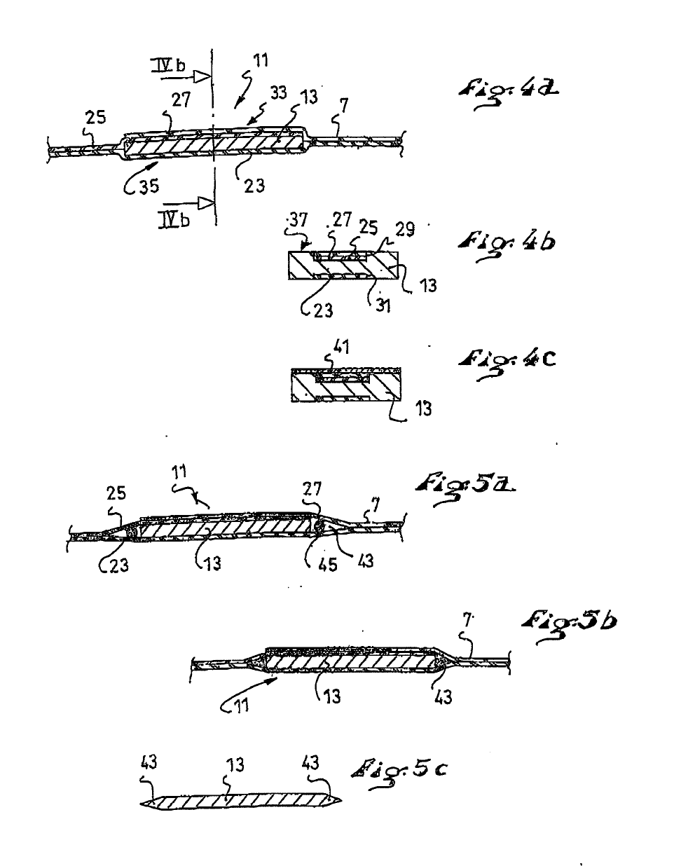

FIGS. 5a and 5b show an example of a connection between the plate 13 and the composite layers of the spoke 7, which slightly differs from that of FIGS. 4a to 4c. Indeed, in the case of FIGS. 5a and 5b, a transitional zone 43 made of melted material is provided between the plate 13 and the layers of composite material. This transitional zone can improve the connection between the plate 13 and the layers of composite material by reducing the risk of the plate layers becoming detached.

The transitional zone 41 is produced by adding a rod or a square made of synthetic material, especially a thermoplastic material, such as designated by the reference numeral 45, in the clearance between the layers 23, 25, 27 and the plate 13, prior to the molding. The rod 45 is melted when the spoke 7 and plate 13 assembly is molded. FIG. 5a shows the rod 45 as inserted prior to molding, and FIG. 5b shows the result obtained after molding. Alternatively, FIG. 5c shows an embodiment in which the plate 13 itself has a generally parallelepiped shape provided with two triangular ends forming the transitional zones which, in this case, do not melt during molding.

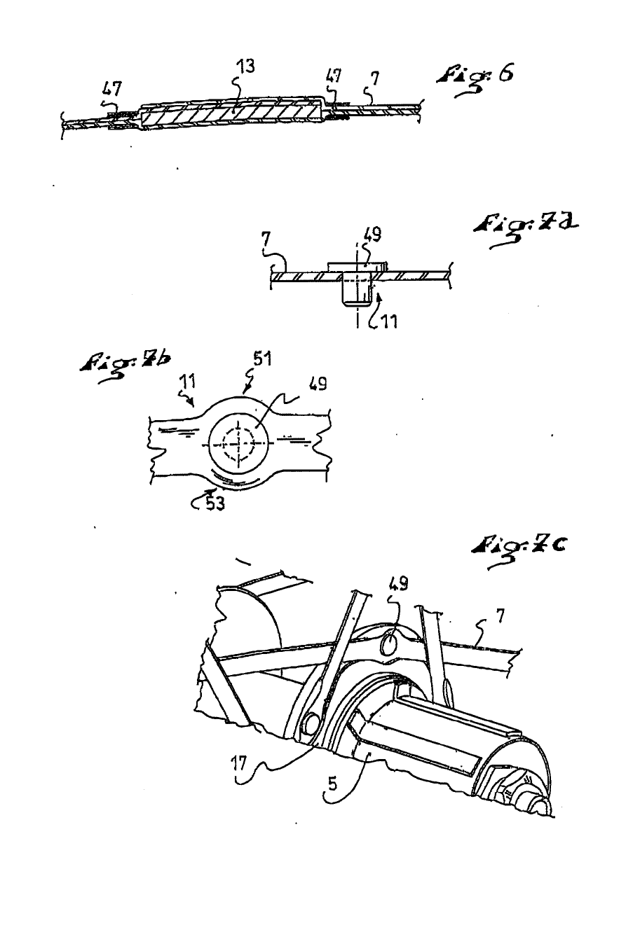

FIG. 6 shows a possibility to improve the gluing between the plate 13 and the spoke 7. This improvement is done by means of tightening straps 47 made of unidirectional carbon fibers wound at each end of the plate 13.

FIGS. 7a to 7c show an alternative attachment arrangement between the hub 5 and the spoke 7. In this alternative, the connection is ensured, not by a plate, but by a shouldered pin 49, i.e., a headed pin. FIG. 7a is a longitudinal partial cross section of the central portion 11 of the spoke 7. FIG. 7b is a top view of the central portion 11. FIG. 7c shows how the pin 49 enables the reversible fastening of the spoke 7 to the flange 17 of the hub 5.

It should be noted that the pin 49 does not interrupt or pierce through the carbon fibers that extend from one end to the other end of the spoke 7. Instead, when the spoke and pin assembly is being molded, the fibers are spaced apart and wrapped around the pin.

With reference to FIG. 7b, the pin 49 is inserted and maintained between two longitudinal outer surfaces 51, 53 of the spoke 7.

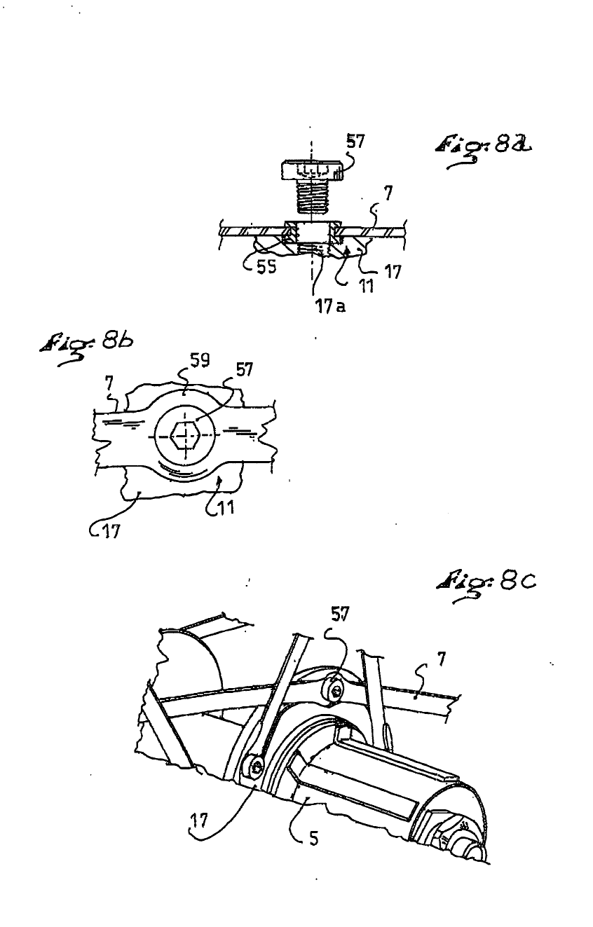

FIGS. 8a to 8c show another alternative of a connection arrangement between the hub 5 and the central portion 11 of the spoke 7. The connection arrangement is a smooth tubular section 55 inserted in the spoke in the same manner as the pin 49. FIG. 8a is a longitudinal partial cross section of the central portion 11 of the spoke 7. FIG. 8b is a top view of the central portion 11. FIG. 8a shows how the tube 55, by means of a screw 57, enables the spoke 7 to be reversibly fastened to the flange 17 of the hub 5, which has a threaded hole 17a. Just as for the pin 49, the carbon fibers are not interrupted by the tube 55 but, instead, they are wrapped around the tube, which causes a bulging area 59.

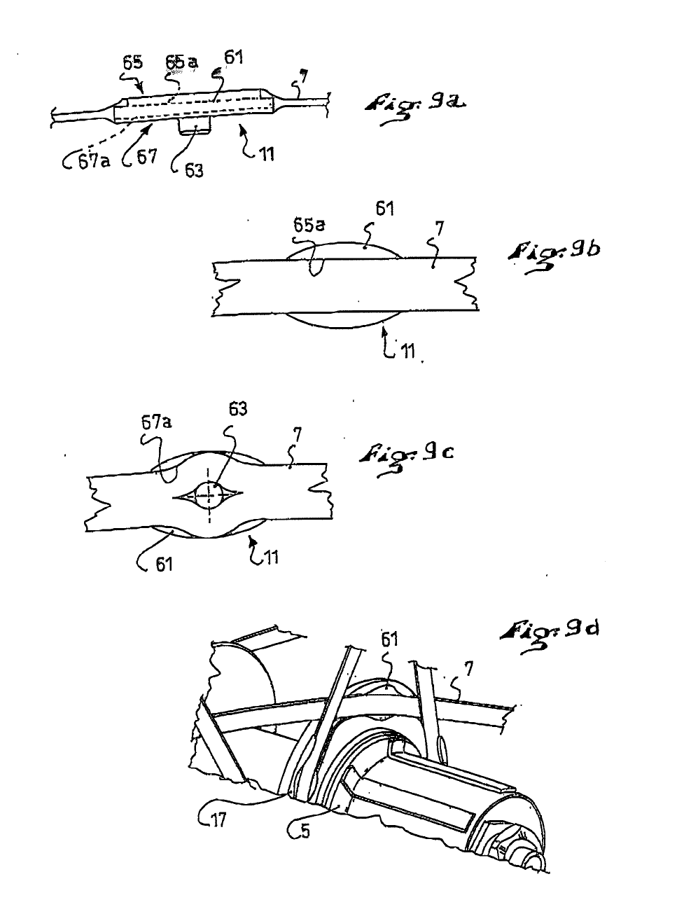

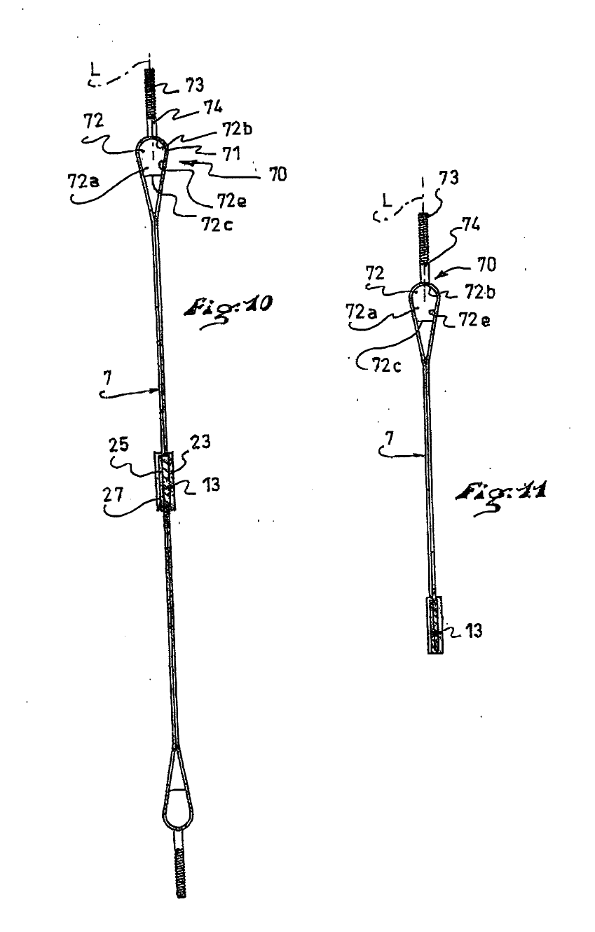

Finally, FIGS. 9a to 9d show another alternative connection arrangement. This time, the connection arrangement is a sort of elliptical plate 61 having a projection 63, such as a pin. In the illustrated example, the projection is shown as a relatively short, cylindrically shaped pin, similar to the pin 49 in an embodiment described above. The elliptical shape of the plate 61 provides a large gluing surface between the plate 61 and the spoke 7. The projection 63 enables the connection with the hub 5.

FIGS. 9a to 9c are a side view, a top view, and a bottom view, respectively, of the central portion, 11 of the spoke 7. FIG. 9d shows how the plate 61 enables the reversible fastening of the spoke 7 to the flange 17 of the hub 5.

FIGS. 9a and 9b show that the upper surface 65 and lower surface 67 of the plate 61 are provided with longitudinal grooves 65a, 67a, respectively, for housing composite layers, in the same manner as the plate 13 of FIGS. 4a to 4c. Just as for the pin 49 and the threaded tube 56, the carbon fibers are wrapped around the projection 63 (see FIG. 9c).

FIGS. 10 and 11 more particularly show a method of removably fastening, or reversibly connecting, the spokes 7 in the area of the rim. The only difference between the two embodiments of these figures is that in the case of FIG. 10, the spoke 7 is a double spoke, i.e., it extends across the diameter of the wheel, whereas in the case of FIG. 11, the spoke is a single spoke.

In the case of FIG. 10, the spoke includes two devices 70 for reversibly connecting to the rim, one at each end, whereas in the case of FIG. 11, the spoke only includes one device 70 for reversibly connecting the spoke to the rim.

In both cases, the fibers of each spoke are arranged to form a loop 71 at each end, adapted to be fixed to the rim, each loop 71 being integral with the elongated body of the spoke 7.

The spoke can be made using any known method, according to a certain number of steps. For example, a multifilament fabric made of dried carbon fibers can be provided to be wound, and then guided in a vat in order to be impregnated with a material that enable the cohesion of the fibers. This can be a thermosetting resin or another material, such as a thermoforming synthetic material. The fabric is then impregnated and wound into a belt. Preferably, several winding turns are provided. This prevents, or substantially reduces, a discontinuity in the thickness of the spoke 7. In fact, it is possible to add localized reinforcements to the belt constituting the spoke in order to adjust the thickness.

The fibers are oriented substantially along the longitudinal direction L of the spoke 7.

The belt is then positioned in a mold in order to be shaped and to be subject to a rise in temperature. Upon exit from the mold, the elongated body of the spoke 7 and the loops 71 for a unitary element, the shape of which is stable. This means that the element does not deform without an external force.

The method for making the connection device 70 can include other steps.

The spoke 7 has the general appearance of a bar, or a band, with a substantially rectangular cross-section, and whose width and thickness are substantially constant. Alternatively, however, the width or the thickness can be provided to vary in order, for example, to provide the spoke 7 with aerodynamic properties. Thus, the cross section of the elongated body of the spoke 7 can be of any shape, including square, rectangular, oblong, elliptical, or the like.

According to the invention, as can be understood with reference to FIGS. 10 and 11, each connection device 70 includes an insert 72 housed in a loop 71, a rod 74 affixed to the insert 72, the rod 74 being oriented along the longitudinal direction L, and defining a first portion 73 for screwing the rod in place. In this case, the first portion 73 is in the form of a threaded end of the rod 74.

The threaded portion 73 is centered in the insert 72, transversely and depthwise, in order to prevent any bending that may hinder its tensile strength.

The threaded portion 73 enables a direct transmission of the forces between the spoke 7 and the rim 3. Indeed, the rod 74 is screwed within a screw nut, which is itself retained within the rim 1 (not shown in the drawing). In this regard, U.S. Patent Application Publication No. 2007/0138859 is hereby incorporated by reference thereto in its entirety.

The first rod 74 is also affixed to the insert 72. The insert extends transversely between two lateral surfaces 72a. These surfaces 72a are substantially planar and are oriented along the longitudinal direction L, for example. The insert 72 has a connection surface 72b between the lateral surfaces 72a. The connection surface is concave. It comes in contact with the fibers of the spoke 7 in order to provide the associated end of the spoke with a loop shape, in the case in which the insert 72 and the belt are positioned simultaneously in the mold. Opposite the connection surface 72b, the insert 72 has a planar end 72c that is perpendicular to the longitudinal direction L of the spoke. The planar end 72c serves to reduce the volume of the insert 72 as much as possible in order to reduce its mass. This lightens the connection device 70.

The insert 72 constitutes a teardrop-shaped assembly that closely fits inside the loop of the associated end of the spoke 7.

According to the first embodiment described, the rod 74 is affixed to the insert 72 by being screw-threadly fitted thereto.

In order to evenly distribute the longitudinal forces that transit via the connection device 70, the first rod 74 is substantially aligned with a central longitudinal axis of the spoke 7. For this reason, the rod 74 is substantially halfway between the lateral surfaces 72e of the insert 72. In a non-limiting manner, the rod 74 can extend through the loop 71 due to the spacing apart of its constituent fibers during manufacture. In fact, another step in the manufacturing method involves spacing the fibers apart and passing the rod 74 through the lop 71 prior to positioning an assembly, including the spoke 7, the first insert 72 and the rod 74, inside the mold. The rod can be screwed into the insert, either before or after it has been positioned in the loop 71.

The connection device 13 is identical to the previously described device and, therefore, it is not described further.

FIGS. 12 to 16 illustrate other embodiments of the reversible connection device 170 in the area of the loop 71 of the spoke, which do not results any screwing into the rim. The only difference with respect to the embodiments of FIGS. 10 and 13 is that the insert, designated here by the reference numeral 172, projects laterally with respect to the body of the spoke 7 and the loop 71 thereof.

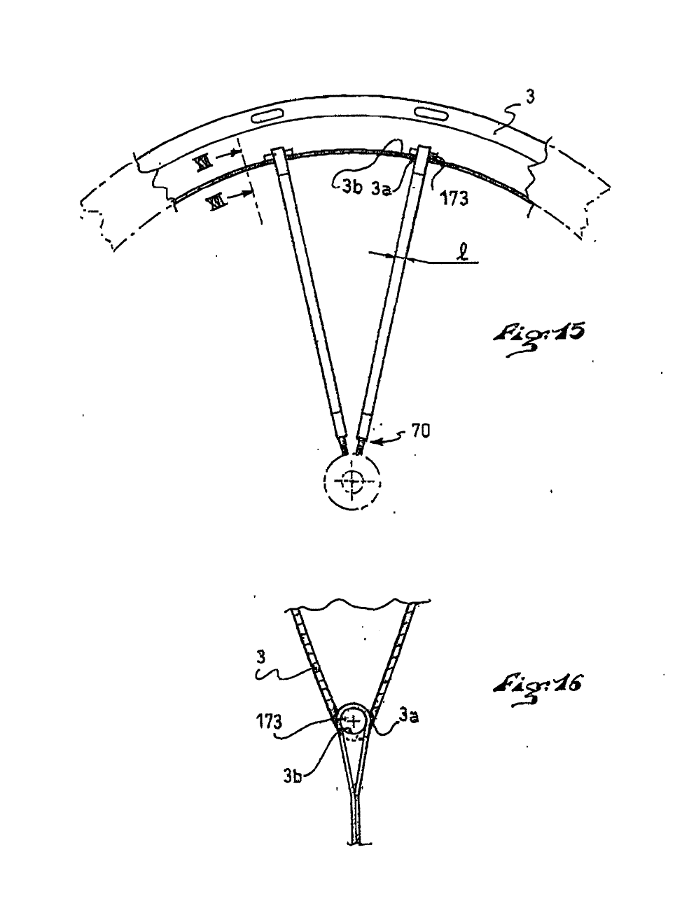

Therefore, the insert 172 substantially has the same teardrop shape as the insert 72 but further has two lateral projections 173 also having a rounded shape. This insert 172 can be a unitary element, as shown in FIG. 12, or can be made of a plurality of portions, as shown in FIGS. 13 and 14.

In the example of FIG. 13, the insert 172 includes a partially cylindrical first portion 173 and a substantially pyramidal portion 174 that is adapted to fill the space between the portion 173 and the remainder of the loop, which makes it possible to optimize the gluing.

In the example of FIG. 14, the insert 172 includes a cylindrical first portion 173 and a substantially pyramidal second portion 174.

FIGS. 15 and 16 illustrate the cooperation of the insert 172 with the rim 3, in the case of a single spoke.

In this case, the rim 3 includes, in the area in which each spoke 7 is fastened, a hole 3a whose width in the circumferential direction corresponds to the width l of the spoke. The insert 172 is then engaged so that its lateral projections 173 are in support on the bottom 3b of the rim, thus achieving the removable and detachable fastening of the spoke to the rim by means of the insert 172 coming in abutment against the bottom of the rim. In this case, the other end of the spoke is provided with a threaded insert 72, such as described in connection with FIGS. 10 and 11, and is therefore attached by screwing into the area of the hub.

The invention is not limited to the particular embodiments that have just been described, and their particular details. Instead, the invention encompasses all of the technical equivalents that fall within the scope of the claims that follow.

1. A wheel comprising:
a rim;
a hub;
at least one spoke connecting the rim to the hub, the spoke being made of composite material;
each spoke including a connection device enabling a reversible connection with the hub;
said connection device being at least partially incorporated with the spoke by having been co-molded with the spoke.

2. A wheel according to claim 1, wherein:
the connection device is positioned and maintained between two longitudinal outer surfaces of the spoke.

3. A wheel according to claim 1, wherein:
the connection device is a plate positioned between composite layers of the spoke.

4. A wheel according to claim 3, wherein:
the connection device comprises two superimposed composite layers on one surface of the plate.

5. A wheel according to claim 3, wherein:
the plate comprises a longitudinal groove for housing at least one composite layer of the spoke.

6. A wheel according to claim 4, wherein;
the two superimposed composite layers are housed in a first, deeper groove of the plate, a third composite layer being housed in a second, shallower groove.

7. A wheel according to claim 3, wherein:
the composite layers in the vicinity of the plate are surrounded by a tightening strap to prevent the layers from delaminating.

8. A wheel according to claim 3, wherein:
a transitional zone is positioned between the plate and the composite layers.

9. A wheel according to claim 3, wherein:
the plate is either planar or comprises two portions, one of said two portions being inclined by a determinate angle with respect to a second of said two portions.

10. A wheel according to claim 3, wherein:
the plate has an elliptical shape and comprises a projection ensuring connection with the hub.

11. A wheel according to claim 1, wherein;
the connection device is a shouldered pin.

12. A wheel according to claim 1, wherein:
the connection device is a threaded tube

13. A wheel according to claim 10, wherein:
the fibers of the composite material surround the connection device on both of opposed sides.

14. A wheel according to claim 1, wherein:
the connection device has a roughened surface obtained by blasting for improving adhesion between the device and the spoke.

15. A wheel according to claim 1, wherein:
the reversible connection is obtained by positioning a connection device in abutment with an associated portion of the wheel.

16. A spoke for a wheel according to claim 1.

17. A spoke according to claim 16, wherein:
the spoke is a double spoke.

18. A spoke according to claim 16, wherein:
the spoke is a double spoke extending substantially across a diameter of the wheel.
